(19) United States
(12) Patent Application Publication
(10) Pub. No.: US 2019/0201842 A1
(43) Pub. Date: Jul. 4, 2019

(54) A PROCESS FOR THE REMOVAL OF SILOXANES FROM LANDFILL GASES

(71) Applicant: Haldor Topsøe A/S, Kgs. Lyngby (DK)

(72) Inventors: Niklas Bengt Jakobsson, Kågeröd (SE); Kresten Egeblad, Farum (DK)

(73) Assignee: Haldor Topsøe A/S, Kgs. Lyngby (SE)

(21) Appl. No.: 16/329,000

(22) PCT Filed: Oct. 10, 2017
(86) PCT No.: PCT/EP2017/075745

§ 371 Date: Feb. 28, 2019

(30) Foreign Application Priority Data
Oct. 17, 2016 (DK) PA 2016 00636

(51) Int. Cl. B01D 53/75; B01D 53/02; B01D 53/81; B01D 53/86; C10L 3/10

(52) U.S. Cl. CPC B01D 53/75; B01D 2255/2092; B01D 53/81; B01D 53/8668; C10L 3/101; B01D 2257/556; B01D 2253/104; B01D 2255/30; B01D 2255/50; B01D 2255/2065; B01D 2258/05; C10L 2200/0469; B01D 2255/20792; B01D 2255/20761; B01D 2255/20723; B01D 2255/20769; B01D 53/02

(57) ABSTRACT

In a process for the removal of siloxanes from biogas streams, especially a landfill gas stream or a gas stream from anaerobic digesters, the gas stream is first passed through a conventional siloxane removing unit to remove the majority of the siloxanes and subsequently passed over a selected catalyst with polishing effect, thereby removing remaining traces of siloxanes. The catalyst with polishing effect is chosen from i.a. zeolites, porous silica, titania and various metals on alumina or titania.

The present invention relates to a novel process for the removal of siloxanes from landfill gases and catalysts for use in the process.

Landfill gas is a gas originating from landfills as a result of various bacterial digestion processes in the landfill itself. The gas typically contains roughly 45-50% CH₄, 45-50% CO₂, up to 1% H₂S, some nitrogen and siloxanes along with low levels of organic sulfur components and volatile organic carbon (VOC) compounds. Landfill gas has a high content of energy and is typically used as a fuel for gas engines, although smaller gas turbines and boilers can also work using landfill gas. In some cases, the gas is upgraded and exported to the public gas grid, or it is used as a fuel gas for other industrial processes. The dominating market today is the US, and reciprocating gas engines are dominating the market for landfill gas utilization.

Siloxanes are organosilicon compounds comprising silicon, carbon, hydrogen and oxygen which have Si—O—Si bonds. Siloxanes can be linear as well as cyclic. They may be present in biogas because they are used in various personal care and beauty products, such as e.g. cosmetics and shampoos that are washed down drains or otherwise disposed of, so that they end up in municipal wastewater and landfills. Siloxanes are not broken down during anaerobic digestion, and as a result, waste gas captured from treatment plants and landfills is often heavily contaminated with these compounds.

Over the years, a growing importance has been attributed to siloxane removal from landfill gases.

It is known that siloxanes can be removed by using non-regenerative packed bed adsorption with activated carbon or porous silica as sorbent. Regenerative sorbents can also be used, as well as units based on gas cooling to very low temperatures, to precipitate the siloxanes out from the gas. Further, liquid extraction technologies are used. In addition, these technologies can be used in combination.

So, besides providing a gas stream with a sufficiently low sulfur content, i.e. less than a few hundred ppm, a major issue in the utilization of raw gas from landfills and anaerobic digesters is to provide a gas stream with a very low content of siloxanes, typically linear or cyclic dimethyl Si—O—Si compounds. Particularly siloxanes give rise to problems because they are converted to SiO₂ during combustion, leading to build-up of abrasive solid deposits inside the engine and causing damage, reduced service time and increased maintenance requirements for many components, such as spark plugs, valves, pistons etc. In addition to causing damage and reduced service time to the engine, also any catalysts installed to control exhaust gas emissions are sensitive to SiO₂ entrained in the gas stream, in fact even more so than the engine itself. For an SCR (selective catalytic reduction) catalyst, for example, the SiO₂ tolerance can be as low as 250 ppb.

It is known in the landfill gas industry that adsorbents, such as activated carbon, silica or alumina, can be used to remove the siloxanes present in the gas. These adsorbents can either be used as scavengers, or they can be used in a regenerative process configuration using temperature swing adsorption.

For the reasons outlined above it is desirable to remove siloxanes and sulfur containing compounds from gas streams to increase the engine service time and the catalyst lifetime. Therefore, a number of patents and patent applications deal with this issue. Thus, WO 2008/024329 A1 discloses a system comprising an adsorbent bed for removing siloxanes from biogas down to a very low siloxane level, so that the cleaned biogas can be used as intake air for equipment, such as combustion engines or gas turbines. The adsorbent bed comprises at least two of activated carbon, silica gel and a molecular sieve.

U.S. Pat. No. 7,393,381 B2 describes the removal of siloxanes from a gas stream using a mineral-based adsorption media called Selective Active Gradient (SAG™), and U.S. Pat. No. 7,410,524 B2 discloses a regenerable purification system (SWOP™) for the removal of siloxanes and volatile organic carbons. These systems can be combined as a continuous SWOP™ adsorption regeneration in a fluidized bed followed by several SAG™ vessels.

US 2010/0063343 A1 describes the cleaning and recovery of a methane fuel from landfill gas, more particularly a process for concentrating and removing certain commonly occurring pollutants from landfill gas. The harmful constituents treated include water, particulates, sulfur (as hydrogen sulfide) and siloxanes.

In U.S. Pat. No. 9,039,807 B2, another regenerative adsorption process for siloxane removal is described. This process uses an adsorbent having a neutral surface, and it is used at a temperature of around 35-50° C. When the adsorbent bed has been filled to capacity, it is heated to remove the siloxanes and regenerate the bed.

Urban, W. et al., Journal of Power Sources vol. 193, 359-366 (2009), discloses a process for removal of siloxanes from a landfill gas stream, where the gas stream is first passed through a conventional siloxane removing unit that is an Al₂O₃-based adsorbent, to remove the majority of the siloxanes and subsequently passed over a V₂O₅/TiO₂-based catalyst with the ability to remove a number of other harmful organic minor compounds.

A similar process for the removal of siloxanes from a biogas stream is disclosed in U.S. Pat. No. 9,217,116, where the gas stream is first passed over an oxidation catalyst comprising V₂O₅ on a metal oxide support, where the catalyst oxidizes 85% or more of the sulfur and halogenated compounds, and subsequently passed over a contaminant removal module containing alkali-impregnated carbon that removes 85% or more of the acidic reaction products. If siloxane impurities are present in the biogas, a contaminant removal module containing Al₂O₃ can be utilized.

US 2012/0301366 discloses a microwave-induced destruction of siloxanes and hydrogen sulfide in biogas, while US 2015/0209717 describes a process for the removal of siloxanes and related compounds from gas streams by adsorption.

EP 1 316 350 A1 describes catalytic transformation of siloxanes into polar compounds and subsequent scrubbing, and DE 10 2004 051 807 A1 describes sorption on a selected hydrophobic silica gel.

Finally, the use of a catalytic oxidation catalyst comprising V₂O₅ on a metal oxide support in a biogas purification system is known from U.S. Pat. No. 9,217,116 B2. The catalyst oxidizes 85% or more of the sulfur and halogenated compounds present in the biogas. The biogas purification system may comprise a contaminant removal module containing alumina oxide to remove part of the siloxane compounds, i.e. 85-98% thereof, prior to removal of the sulfur and halogenated compounds. Siloxanes introduce issues for boilers, gas engines and gas turbines where they cause excessive wear on the equipment, fouling and frequent lubrication oil change-outs. Siloxanes are furthermore known to severely poison catalysts used in landfill gas processing and flue gas treatment. It is well known that vanadia-based metal oxide catalysts are readily poisoned by siloxanes present in flue gas from landfill gases to power generation plants.

The idea underlying the present invention is (1) to use an alumina-based sorbent operated at temperatures between 300 and 450° C. to adsorb the majority of the siloxanes present in the landfill gas and (2) to subsequently use a specially selected catalyst, also operated at temperatures between 300 and 450° C., to act as a polisher to remove any remaining trace of siloxanes from the gas. This polishing catalyst is more specifically chosen from zeolites, porous silica, titania, nickel on alumina, manganese on alumina, molybdenum on alumina, cobalt on alumina, a combination of any or all of cobalt, molybdenum and nickel on alumina, copper and manganese on alumina, vanadia on titania, molybdenum on titania, zinc oxide, copper supported on zinc oxide, and cerium oxide.

So the present invention relates to a process for the removal of siloxanes from biogas streams, especially a landfill gas stream or a gas stream from anaerobic digesters, wherein the gas stream is first passed through a conventional siloxane removing unit and then passed over a selected catalyst with polishing effect, thereby removing any remaining traces of siloxanes, and wherein the catalyst with polishing effect is selected among those cited above.

The siloxane removing unit comprising an alumina-based adsorbent is operated at temperatures between 300 and 450° C., at which temperatures the majority of the siloxanes are adsorbed. The selected catalyst with polishing effect is also operated at temperatures between 300 and 450° C.

The heat required to perform siloxane removal at temperatures between 300 and 450° C. is provided by combusting a portion of the cleaned product landfill gas from the unit to supply a hot flue gas that heats the process gas upstream from the siloxane removal reactor and—in this manner—enabling the use of abundant landfill gas as a fuel and at the same time avoiding silica deposits in such a gas fired heater.

1. A process for the removal of siloxanes from biogas streams, especially a landfill gas stream or a gas stream from anaerobic digesters, wherein the gas stream is first passed through a conventional siloxane removing unit to remove the majority of the siloxanes and subsequently passed over a selected catalyst with polishing effect, thereby removing any remaining traces of siloxanes.

2. Process according to claim 1, wherein the catalyst with polishing effect is chosen from zeolites, porous silica, titania, nickel on alumina, manganese on alumina, molybdenum on alumina, cobalt on alumina, a combination of any or all of cobalt, molybdenum and nickel on alumina, copper and manganese on alumina, vanadia on titania, molybdenum on titania, zinc oxide, copper supported on zinc oxide, and cerium oxide.

3. Process according to claim 1, wherein the siloxane removing unit comprises an alumina-based adsorbent.

4. Process according to claim 1, wherein the siloxane removing unit and the catalyst with polishing effect are both operated at temperatures between 300 and 450° C.

5. Process according to claim 4, wherein the heat required to perform siloxane removal at temperatures between 300 and 450° C. is provided by combusting a portion of the cleaned product landfill gas from the siloxane removing unit to supply a hot flue gas that heats the process gas upstream from the siloxane removal reactor.
